(19) United States
(12) Patent Application Publication
(10) Pub. No.: US 2006/0232181 A1
(43) Pub. Date: Oct. 19, 2006

(54) Shadow mask for Cathode Ray Tube (CRT)

(76) Inventors: Do-Hun Pyun, Suwon-si (KR); Chan-Yong Kim, Suwon-si (KR); Soon-Dong Jeong, Suwon-si (KR)

Correspondence Address: Robert E. Bushnell, Suite 300, 1522 K Street, N.W., Washington, DC, 20005, US

(21) Appl. No.: 11/373,326

(22) Filed: Mar. 13, 2006

(30) Foreign Application Priority Data
Apr. 15, 2005 (KR) 10-2005-0031393

(51) Int. Cl. H01J 29/81; H01J 29/07

(52) U.S. Cl. 313/402; 313/403

(57) ABSTRACT

A shadow mask for a Cathode Ray Tube (CRT) facilitates high resolution with enhanced impact resistance and minimized thickness. The shadow mask has an effective screen portion with a plurality of beam passage holes arranged in a predetermined pattern, and a non-holed portion surrounding the effective screen portion with no beam passage holes., The vertical pitch of the beam passage holes is in the range of 0.4-0.5 mm, and the thickness of the shadow mask is in the range of 0.15-0.2 mm.

### CLAIM OF PRIORITY

This application makes reference to, incorporates the same herein, and claims all benefits accruing under 35 U.S.C. §119 from an application for SHADOW MASK FOR CATHODE RAY TUBE earlier filed in the Korean Intellectual Property Office on the 15^{th} of April 2005 and there duly assigned Serial No. 10-2005-0031393.

### BACKGROUND OF THE INVENTION

1. Field of the Invention

The present invention relates to a shadow mask for a Cathode Ray Tube (CRT), and more particularly, to a shadow mask for a CRT which has minimized thickness by controlling the vertical pitch of beam passage holes to achieve high resolution.

2. Description of the Related Art

Generally, a Cathode Ray Tube (CRT) is an electronic tube where electron beams emitted from an electron gun are deflected due to a deflection magnetic field, pass through a color selection shadow mask, and then strike and excite green, blue, and red phosphors on a phosphor film within a panel, thereby displaying desired images.

The shadow mask has a color selection function of selecting the emitted electron beams and landing them on the phosphor film. For this purpose, beam passage holes are arranged at the shadow mask in a predetermined pattern to pass the electron beams.

The beam passage holes of the shadow mask are formed in the shape of a circle or a rectangle. When the beam passage holes have a rectangular shape, the long sides thereof proceed parallel to the vertical line of the shadow mask. The beam passage holes are disposed between bridge portions.

The beam passage holes are formed using a photo etching technique such that the etching is made at both surfaces of the shadow mask. That is, a photoresist is coated onto both surfaces of the shadow mask material, and a pair of disks patterned corresponding to the beam passage holes to be formed are tightly adhered to the photoresist films, followed by exposing the material to light, and developing it to form photoresist patterns corresponding to those of the disks. The shadow mask material with the photoresist patterns is etched at both surfaces thereof to thereby form the beam passage holes.

The horizontal pitch of the beam passage holes should be minimized to fabricate a high resolution CRT. For instance, in order to fabricate a CRT with a high resolution of 1280×1080 or more based on the dimension of 32″, the horizontal pitch of the beam passage holes should be about 0.4 mm when the size of the horizontal effective portion of the shadow mask is established to be 610 mm.

The width of the beam passage holes should be about 0.1 mm, which is 25% of the horizontal pitch. However, it is impossible to etch a beam passage hole with a width of 0.1 mm when the thickness of the shadow mask is 0.22 mm. That is, in order to etch the beam passage hole with a width of 0.1 mm, the thickness of the shadow mask should be 0.2 mm or less.

However, when the thickness of the shadow mask is 0.2 mm or less, the intensity of the shadow mask becomes so weak as to make fabricating it difficult.

### SUMMARY OF THE INVENTION

It is an object of the present invention to provide a shadow mask for a Cathode Ray Tube (CRT) which has a minimized thickness with a reasonable impact resistance by controlling the vertical pitch of beam passage holes to achieve a high resolution.

This and other objects may be achieved by a shadow mask for a CRT with the following features.

A shadow mask for a CRT includes an effective screen portion with a plurality of beam passage holes arranged in a predetermined pattern, and a non-holed portion surrounding the effective screen portion with no beam passage holes. The vertical pitch of the beam passage holes is in the range of 0.4-0.5 mm.

The thickness of the shadow mask is in the range of 0.15-0.2 mm.

With this structure, the beam passage holes can be etched enough to achieve a high resolution, and the thickness of the shadow mask can be reduced to provide a high resolution CRT.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a perspective view of a Cathode Ray Tube (CRT) with a shadow mask according to an embodiment of the present invention;

FIG. 2 is a perspective view of the shadow mask of the CRT according to the embodiment of the present invention;

FIG. 3 is a partial amplified plan view of the shadow mask of the CRT according to the embodiment of the present invention;

FIG. 4 is a graph of the impact values as a function of the variation in vertical pitch with the shadow mask of the CRT according to the embodiment of the present invention; and

FIG. 5 is a graph of the variation in light transmittance as a function of the variation in vertical pitch with the shadow mask of the CRT according to the embodiment of the present invention.

### DETAILED DESCRIPTION OF THE INVENTION

The present invention will be described more fully hereinafter with reference to the accompanying drawings, in which an exemplary embodiment of the present invention is shown.

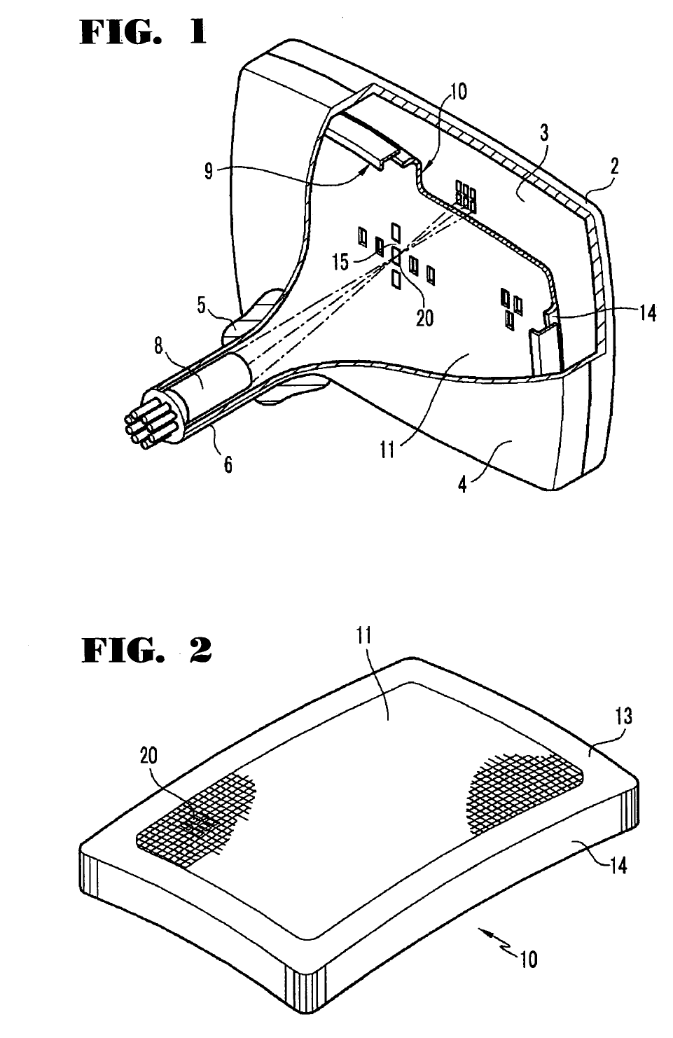

FIG. 1 is a perspective view of a Cathode Ray Tube (CRT) with a shadow mask according to an embodiment of the present invention. As shown in FIG. 1, the CRT 100 is formed with a vacuum vessel having a panel 2, a funnel 4, and a neck 6, and an electron gun 8. A deflection yoke 5 is arranged on the vacuum vessel.

A phosphor film 3 is formed on the inner surface of the panel 2 with red R, green G, and blue B phosphors patterned while interposing a black matrix BM.

The electron gun 8 is arranged within the neck 6 to emit electrons, and the deflection yoke 5 is arranged around the outer circumference of the funnel 4 to deflect the electron beams emitted by the electron gun 8.

The panel 2, the funnel 4, and the neck 6 are integrated into one body to thereby form a vacuum vessel.

A shadow mask 10 is installed on the panel 2 such that it is spaced apart from the phosphor film 3 by a predetermined distance while being supported by a frame 9.

In this embodiment, a plurality of beam passage holes 20 are formed in the shadow is mask 10 with a predetermined pattern to pass the electron beams.

With the CRT 100, the electron beams emitted by the electron gun 8 are deflected due to the deflection magnetic field of the deflection yoke 9, and pass through the beam passage holes 20 of the color selection shadow mask 10. The electron beams then collide with the green, blue, and red phosphors of the phosphor film 3 formed on the inner surface of the panel 2. Consequently, the phosphors are excited to thereby display the desired images. The structure of the shadow mask 10 according to the embodiment of the present invention is explained below in detail.

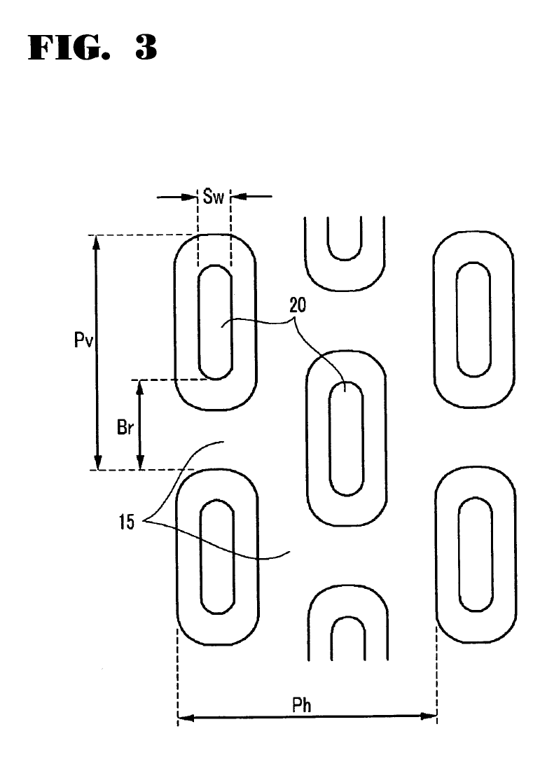

FIG. 2 is a perspective view of the shadow mask of the CRT according to the embodiment of the present invention.

As shown in FIG. 2, the shadow mask 10 has an effective screen portion 11 having beam passage holes 20 to display the desired images, and a non-holed portion 13 having no beam-passage holes and not displaying the images.

The effective screen portion 11 is completely surrounded by the non-holed portion 13. That is, the non-holed portion 13 surrounds the effective screen portion 11 as a rim.

The shadow mask 10 has a skirt portion 14 extending from the edge of the non-holed portion 13 toward the frame 9 to fix the shadow mask 10 to the frame 9.

Each beam passage hole 20 has a large-sized hole portion on a side facing the panel 2, and a small-sized hole portion on a side facing the electron gun 8. The small-sized hole portion can be concentric or eccentric with the large-sized hole portion.

The eccentricity of the small-sized hole portion with respect to the large-sized hole portion is determined by the deflection angle and the deviation (the spatial distance) of the relevant beam passage hole 20 from the center of the effective screen portion 11. The direction of eccentricity is determined depending upon the location of the beam passage hole 20 when the effective screen portion 11 is divided into quadrants.

FIG. 3 is an amplified plan view of the shadow mask of the CRT according to the embodiment of the present invention. As shown in FIG. 3, a bridge portion 15 is disposed between the beam passage holes 20 to sustain the intensity and shape of the shadow mask.

The beam passage hole 20 is formed in the shape of a rectangle or a stripe such that the long sides thereof are parallel to the vertical line of the effective screen portion 11.

The vertical pitch Pv of the beam passage hole 20 is in the range of 0.4-0.5 mm. The vertical pitch Pv of the beam passage holes 20 is the distance between the neighboring beam passage holes 20 on the same column. The vertical pitch Pv contains the length Br of the bridge portion 15.

The horizontal pitch Ph of the beam passage holes 20 is the distance between the neighboring beam passage holes 20 on the same row.

In this embodiment, the thickness of the shadow mask is in the range of 0.15-0.2 mm.

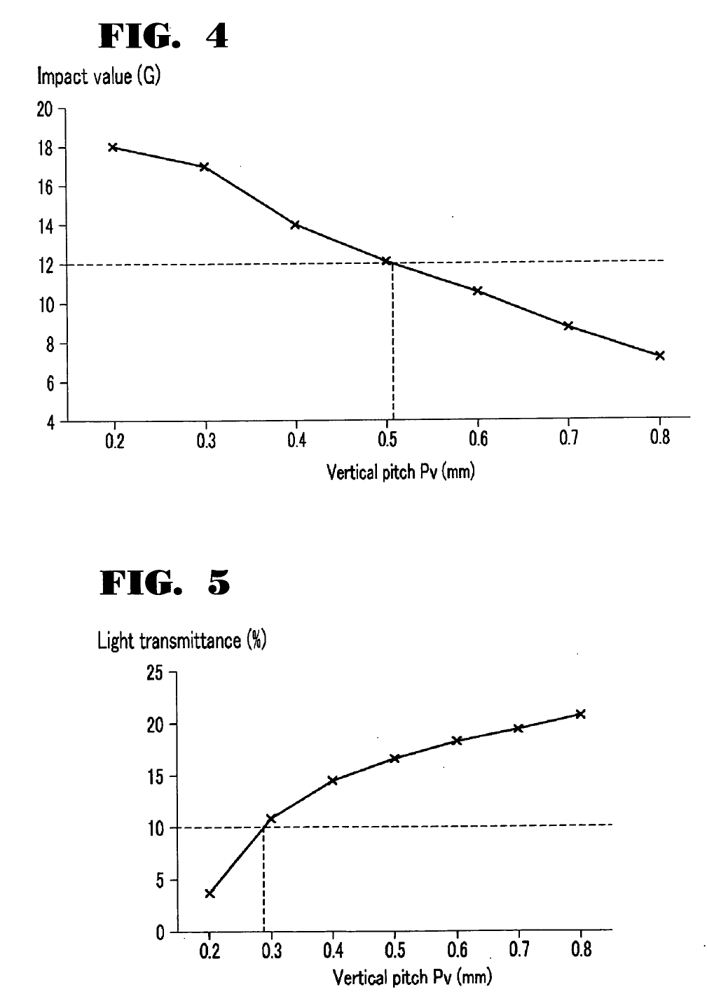

FIG. 4 is a graph of the impact values as a function of the variation in vertical pitch with the shadow mask of the CRT according to the embodiment of the present invention. The thickness of the shadow mask 10 was 0.18 mm, the horizontal pitch Ph was 0.4 mm, the width Sw of the small-sized hole portion of the beam passage hole 20 was 0.1 mm, and the length Br of the bridge portion 15 was 0.15 mm. The vertical pitch Pv was set to 0.2 mm, 0.3 mm, 0.4 mm, 0.5 mm, 0.6 mm, 0.7 mm, and 0.8 mm.

Generally, the unit of the impact value is indicated by G, and the impact environment of the products during circulation is judged to be safe when the interpreted value of half a sine wave is 12 G or more.

As shown in FIG. 4, when the impact value is 12 G or more, the vertical pitch Pv is 0.5 mm or less.

That is, the smaller the vertical pitch Pv is, the number of bridges 15 interconnecting the beam passage holes 20 becomes increased, and this is advantageous in the impact environment.

However, when the vertical pitch Pv is too small, the light transmittance becomes lowered, thereby reducing the brightness, and hence, it is important to take into account the light transmittance. The light transmittance T can be estimated as a function of the vertical pitch Pv, the horizontal pitch Ph, the width Sw of the small-sized hole portion of the beam passage holes 20, and the length Br of the bridge portion 15. The light transmittance can be expressed by the formula: T=(Sw×(Pv−Sw−Br)+π×Sw²/4)/(Ph×Pv).

Table 1 lists the results of interpreting the light transmittance %, in association with FIG. 5. The thickness of the shadow mask was 0.18 mm, the horizontal pitch Ph was 0.4 mm, the width Sw of the small-sized hole portion of the beam passage holes 20 was 0.1 mm, and the length Br of the bridge portion 15 was 0.15 mm. The vertical pitch Pv was set to 0.2 mm, 0.3 mm, 0.4 mm, 0.5 mm, 0.6 mm, 0.7 mm, 0.8 mm, and 0.9 mm

TABLE 1

| | Width of | Vertical | Length of | Light |
|---|---|---|---|---|
| Horizontal | small-sized hole | pitch | bridge | transmittance |
| pitch Ph (mm) | portion Sw (mm) | Pv (mm) | Br (mm) | (%) |
| 0.4 | 0.1 | 0.2 | 0.15 | 3.6 |
| | | 0.3 | | 10.7 |
| | | 0.4 | | 14.3 |
| | | 0.5 | | 16.4 |
| | | 0.6 | | 17.9 |
| | | 0.7 | | 18.9 |
| | | 0.8 | | 19.6 |
| | | 0.9 | | 20.2 |

It is generally possible to obtain sufficient brightness only when the light transmittance is 10% or more. Considering the deterioration in brightness and safety, it is advantageous to establish the vertical pitch Pv to be 0.4 mm or more.

Considering the impact value (intensity) and the brightness (light transmittance) together, the vertical pitch Pv should be 0.4-0.5 mm. Particularly, it is preferable in both aspects of intensity and light transmittance that the vertical pitch Pv is 0.45 mm.

When the vertical pitch Pv is reduced, the Moire phenomenon due to the interference between the scanning pitch Ps and the vertical pitch Pv is decreased. Therefore, the focusing characteristic, contrary to the Moire phenomenon, is improved to thereby achieve high resolution.

That is, the Moire wavelength λ is estimated as a function of the scanning pitch Ps and the vertical pitch Pv, and is expressed by the formula: λ=1/(2/Pv−n/Ps). The smaller the vertical pitch Pv is, the more the Moire wavelength λ is decreased.

With the above-structured shadow mask for a CRT according to the present invention, even when the thickness thereof is 0.2 mm or less (preferably in the range of 0.1 5-0.20 mm), when the vertical pitch Pv is in the range of 0.4-0.5 mm, it is possible to obtain sufficient intensity. Furthermore, even when the vertical pitch Ph is less than 0.4 mm, the etching of the beam passage holes 20 can be made.

Accordingly, it is possible to achieve a high resolution where the value of the horizontal length of the effective screen portion 11 divided by the horizontal pitch Ph of the beam passage holes is in the range of 1200-1500.

Furthermore, it is advantageous in doming with the shadow mask for the CRT according to the present invention that when the thickness thereof is 0.2 mm or less, it is formed of a material having a thermal expansion coefficient of 1.0×10⁻⁶/° C. or less.

With the shadow mask of the present invention, it is very effective for achieving high resolution that the horizontal length of the panel 2 is 600 mm or more.

Although an exemplary embodiment of the present invention has been described in detail hereinabove, it should be clearly understood that many variations and/or modifications of the basic inventive concept herein still fall within the spirit and scope of the present invention, as defined by the appended claims.

What is claimed is:

1. A shadow mask for a Cathode Ray Tube (CRT), comprising:
an effective screen portion including a plurality of beam passage holes arranged in a predetermined pattern; and
a non-holed portion surrounding the effective screen portion and including no beam passage holes;
wherein the vertical pitch of the beam passage holes is in the range of 0.4-0.5 mm.

2. The shadow mask for a CRT of claim 1, comprising a thickness of 0.1 5-0.2 mm.

3. The shadow mask for a CRT of claim 1, wherein the beam passage hole is in the shape of either a rectangle or a stripe, and wherein long sides of the beam passage hole are parallel to a vertical line of the effective screen portion.

4. The shadow mask for a CRT of claim 1, wherein a horizontal length of the effective screen portion divided by a horizontal pitch of the beam passage holes is in the range of 1200-1500.

5. The shadow mask for a CRT of claim 1, comprising a material having a thermal expansion coefficient of 1.0×10⁻⁶/° C.

6. A Cathode Ray Tube (CRT), comprising:
a panel having a phosphor film on an inner surface thereof;
a funnel attached to the panel;
a neck attached to the funnel;
an electron gun arranged within the neck to emit electron beams;
a deflection yoke arranged around an outer circumference of the funnel to deflect electron beams emitted by the electron gun; and
a shadow mask arranged within the panel to color-selectively pass the electron beams emitted by the electron gun, the shadow mask including an effective screen portion having a plurality of beam passage holes arranged in a predetermined pattern, and a non-holed portion surrounding the effective screen portion and having no beam passage holes;
wherein a vertical pitch of the beam passage holes is in the range of 0.4-0.5 mm, and a thickness of the shadow mask is in the range of 0.15-0.2 mm.

7. The CRT of claim 6, wherein a horizontal length of the effective screen portion divided by a horizontal pitch of the beam passage holes is in the range of 1200-1500.

8. The CRT of claim 6, wherein the shadow mask comprises a material having a thermal expansion coefficient of 1.0×10⁻⁶/° C.

9. The CRT of claim 6, wherein a horizontal length of the panel is at least 600 mm.
